(19) United States
(12) Patent Application Publication
(10) Pub. No.: US 2022/0070332 A1
(43) Pub. Date: Mar. 3, 2022

(54) NON-TRANSITORY COMPUTER-READABLE STORAGE MEDIUM STORING PRINT CONTROL PROGRAM, CONTROL METHOD OF PRINT CONTROLLER, AND PRINT CONTROLLER

(71) Applicant: SEIKO EPSON CORPORATION, Tokyo (JP)

(72) Inventors: Yuki IKEDA, Shiojiri-shi (JP); Taketo KURIBAYASHI, Nagano-shi (JP); Kazuki OHASHI, Shiojiri-shi (JP)

(21) Appl. No.: 17/459,641

(22) Filed: Aug. 27, 2021

(30) Foreign Application Priority Data
Sep. 2, 2020 (JP) 2020-147359

(51) Int. Cl. H04N 1/34; G06F 3/12; H04N 1/00; G06Q 10/10

(52) U.S. Cl. CPC H04N 1/342; G06F 3/126; G06Q 10/10; G06F 3/1293; H04N 1/00244

(57) ABSTRACT

A charging application to be executed by a terminal processor of a terminal device causes the terminal processor to store a print queue associated with a server to which charging information is transmitted, to monitor a spooler receiving a print job, when the spooler receives the print job specifying the print queue, to obtain charging information based on the print job, and to transmit the obtained charging information to the server associated with the print queue.

The present application is based on, and claims priority from JP Application Serial Number 2020-147359, filed Sep. 2, 2020, the disclosure of which is hereby incorporated by reference herein in its entirety.

### BACKGROUND

### 1. Technical Field

The present disclosure relates to a non-transitory computer-readable storage medium storing a print control program, a method of controlling a print controller, and a print controller.

### 2. Related Art

Techniques for transmitting information based on a print job to the outside are known. For example, JP-A-2004-303236 discloses a technique for transmitting, to a charging system, processing information representing actually executed processing for an authenticated print job.

However, in JP-A-2004-303236, the processing information on all of the authenticated print jobs is transmitted to the charging system. Accordingly, with JP-A-2004-303236, for example, a print job that a user does not consider as a charging target is also charged.

### SUMMARY

According to an aspect of the present disclosure, there is provided a non-transitory computer-readable storage medium storing a print control program to be executed by a computer of a print controller, the print controller connected to a server and a printer and including a spooler operating to receive a print job and transmit the print job to the printer, the print control program causing the computer to perform processing, the processing including: storing a print queue associated with the server; monitoring the spooler; when the spooler receives the print job, in a case in which the received print job specifies the print queue, obtaining print information based on the print job; and transmitting the obtained print information to the server associated with the print queue.

According to another aspect of the present disclosure, there is provided a method of controlling a print controller connected to a server and a printer, the method including: storing a print queue associated with the server; receiving a print job by using a spooler; determining whether or not the print job received by the spooler specifies the print queue; when determining that the print job specifies the print queue, transmitting print information based on the print job to the server associated with the print queue.

According to still another aspect of the present disclosure, there is provided a print controller connected to a server and a printer, including: a storage section configured to store a print queue associated with the server; a spooler configured to receive a print job; a monitoring section configured to monitor the spooler; and a print information transmission section configured to transmit print information based on the print job to the print queue and the server when the monitoring section determines that the print job received by the spooler specifies a print queue.

### BRIEF DESCRIPTION OF THE DRAWINGS

FIG. 1 is a diagram illustrating the configuration of a printing system.

FIG. 2 is an explanatory diagram of a charging application execution section.

FIG. 3 is a flowchart illustrating the operation of a terminal device.

### DESCRIPTION OF EXEMPLARY EMBODIMENTS

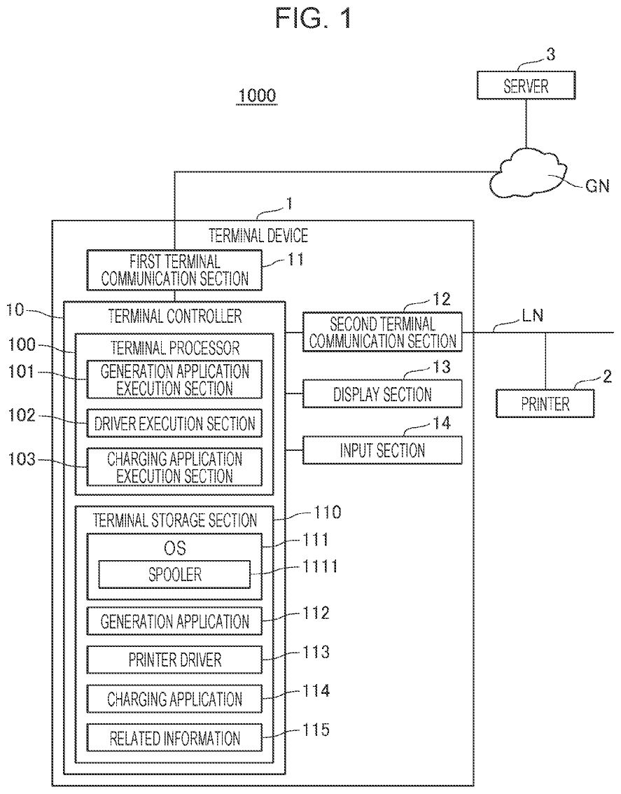

FIG. 1 is a diagram illustrating the configuration of a printing system 1000.

As illustrated in FIG. 1, the printing system 1000 includes a terminal device 1. The terminal device 1 corresponds to an example of the print controller.

The terminal device 1 is a PC (personal computer). The terminal device 1 may be a desktop PC, a laptop PC, or a tablet PC. The terminal device 1 is connected to a printer 2 via a local network LN in a communicable manner with a server 3 via a global network GN. The global network GN is configured by including a dedicated line, a public line network, the Internet, or the like.

The printing system 1000 includes the printer 2. The printer 2 is a device that prints an image on a print medium. The type of the print medium is not limited, and a predetermined size of cut paper, roll paper, synthetic resin sheet, and the like are examples. The printing method of the printer 2 is not limited. It is possible to employ a printing method, such as a dot impact type, a thermal sublimation type, a thermal type, or the like. In the present embodiment, an example in which the printing method of the printer 2 is an ink jet method is exemplified.

One or a plurality of printers of different models or from different manufacturers may be connected to the terminal device 1.

The printing system 1000 includes the server 3. The server 3 is a server device that receives charging information related to the charging of printing performed by the printer 2 and performs various kinds of processing related to the charging, such as the calculation of the charge amount, the invoicing of the charge amount, and the like based on the received charging information. The charging information includes various kinds of information, such as the number of sheets printed, the print medium size, such as A4, or the like, a print mode indicating either color printing or monochrome printing, and the like. The charging information corresponds to an example of the print information.

The terminal device 1 may be connected to one or a plurality of other servers. The other servers are servers configured to process the charging information related to the printing performed by printers other than the printer 2.

A description will be given of the configuration of the terminal device 1. The terminal device 1 includes a terminal controller 10, a first terminal communication section 11, a second terminal communication section 12, a display section 13, and an input section 14.

The terminal controller 10 includes a terminal processor 100, which is a processor, such as a CPU (central processing unit), an MPU (micro-processing unit), or the like, that executes a program, and a terminal storage section 110, which is a memory, such as RAM (random access memory), ROM (read-only memory), or the like, and controls each section of the terminal device 1. The terminal processor 100 corresponds to an example of the computer. The terminal storage section 110 corresponds to an example of the storage section. The terminal controller 10 reads a program stored in the terminal storage section 110 and performs various kinds of processing using a combination of hardware and software. The terminal controller 10 functions as a generation application execution section 101 by the terminal processor 100 executing a generation application 112 stored in the terminal storage section 110. The terminal controller 10 functions as a driver execution section 102 by the terminal processor 100 executing a printer driver 113 stored in the terminal storage section 110. The terminal controller 10 functions as a charging application execution section 103 by the terminal processor 100 executing a charging application 114 stored in the terminal storage section 110. Descriptions of these functional sections will be given later.

The generation application 112 is an application program that generates data of documents and images. The charging application 114 is an application program related to the charging of printing performed by the printer 2. The charging application 114 corresponds to an example of the print control program.

The terminal storage section 110 includes a storage area that stores programs executed by the terminal processor 100 and data to be processed by the terminal processor 100. The terminal storage section 110 stores an operating system 111, a generation application 112, a printer driver 113, a charging application 114, related information 115, and various kinds of other data. The terminal storage section 110 includes a nonvolatile storage area. The terminal storage section 110 may include a volatile storage area and serve as a work area of the terminal processor 100. In the following description, the operating system 111 is abbreviated as the OS 111.

The first terminal communication section 11 includes communication hardware conforming to a predetermined communication standard and communicates with the server 3 connected via a global network GN under the control of the terminal controller 10.

The second terminal communication section 12 includes communication hardware conforming to a predetermined communication standard and communicates with the printer 2 connected via a local network LN under the control of the terminal controller 10. The second terminal communication section 12 may communicate with printer 2 by using a USB connection via a USB cable.

The display section 13 is a display panel configured by an LED (light emitting diode), an OLED (organic light emitting diode), or the like included in the terminal device 1 and displays information under the control of the terminal controller 10. The display section 13 may be an external display connected to the terminal device 1.

The input section 14 is an interface that is coupled to an input mechanism, such as a touch panel, a mouse, a keyboard, or the like, and detects a user operation performed on the input mechanism and outputs a detection result to the terminal controller 10. The terminal controller 10 performs processing corresponding to the operation on the input mechanism based on the input from the input section 14. The input mechanism, such as an operation switch, may be included in the terminal device 1.

The terminal controller 10 functions as the generation application execution section 101, the driver execution section 102, and the charging application execution section 103.

The generation application execution section 101 generates the data of documents, images, and the like to be printed by the printer 2 in accordance with the user operation performed on the terminal device 1.

The driver execution section 102 generates a print job by using the function of the printer driver 113 in accordance with the data generated by the generation application execution section 101. The print job includes the data generated by the generation application execution section 101, various commands for printing the data, and the like. When the driver execution section 102 generates a print job, the driver execution section 102 outputs the print job to a spooler 1111.

The spooler 1111 is an API (application programming interface) provided by the OS 111 and used by the generation application 112 and the printer driver 113. The spooler 1111 receives a print job output by the driver execution section 102, temporarily stores the print job in a print queue specified by the received print job, and outputs the print job to the printer 2 in accordance with the state of the printer 2 corresponding to the print queue. The print queue is created in a predetermined user-definable storage area of the terminal storage section 110 depending on the printer 2 connected to the terminal device 1, a printing application, and the like. When the terminal device 1 is connected to a printer different from the printer 2, a print queue corresponding to the other printer is created by the user in a predetermined storage area. When the printer 2 is used for both private printing and business printing, a print queue used for private printing and a print queue used for business printing are created by the user in a predetermined storage area. The print queue for use in business printing corresponds to the print queue associated with the server 3, and the print queue for use in private printing corresponds to the second print queue.

The spooler 1111 receives a print end response for the transmitted print job or an error response for the transmitted print job from the printer 2 to which the spooler 1111 has transmitted the print job. The print end response is a response indicating that the printing based on the print job has ended. When the printer 2 ends the printing based on the print job received from the spooler 1111, the printer 2 transmits a print end response to the spooler 1111. The error response is a response indicating that an error, such as no paper, an ink shortage, or the like, has occurred at the time of the printing based on the print job. When an error occurs during the printing based on the print job received from the spooler 1111, the printer 2 transmits an error response to the spooler 1111.

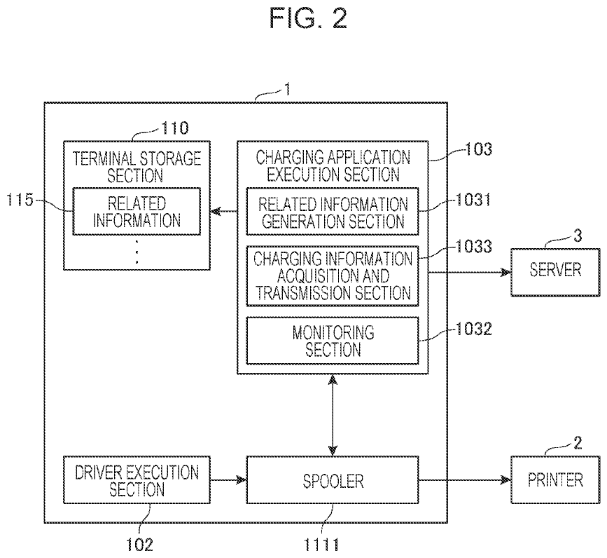

FIG. 2 is an explanatory diagram of the charging application execution section 103. The charging application execution section 103 includes a related information generation section 1031, a monitoring section 1032, and a charging information acquisition and transmission section 1033 as functional sections. The charging information acquisition and transmission section 1033 corresponds to an example of the print information transmission section.

The related information generation section 1031 generates related information 115. The related information 115 is information associating a print queue and the server 3 and includes information identifying a print queue and the address of the server 3. The information identifying a print queue includes a port number to which the corresponding printer 2 is coupled, the name of the corresponding printer 2, and the like.

The related information generation section 1031 causes the display section 13 to display a user interface associating a print queue and the server 3 at the time of generating related information 115. The related information generation section 1031 receives user input specifying a print queue and the server 3 via the user interface. The related information generation section 1031 generates the related information 115 associating the print queue specified by the user and the server 3 in accordance with the user input. The related information generation section 1031 stores the generated related information 115 in the terminal storage section 110.

The monitoring section 1032 monitors the spooler 1111. The monitoring section 1032 monitors whether or not the print queue included in the related information 115 has stored a print job so as to monitor whether or not the print job received by the spooler 1111 is a print job specifying a print queue included in the related information 115.

The monitoring section 1032 monitors whether or not the spooler 1111 has received a print end response or an error response for the transmitted print job.

When the monitoring section 1032 determines that the spooler 1111 has received a print job specifying a print queue included in the related information 115, the charging information acquisition and transmission section 1033 obtains charging information from the print job. When the spooler 1111 receives a print job specifying a print queue other than the print queue included in the related information 115, the charging application execution section 103 does not obtain the charging information from the print job.

The charging information acquisition and transmission section 1033 obtains charging information from the print processing information included in the print job. The print processing information is the information commonly included in the print job without depending on the command system of the command included in the print job. The print processing information is referred to as a DEVMODE structure. The charging information acquisition and transmission section 1033 refers to the print processing information to obtain the charging information without performing the command analysis. Thereby, it is possible for the charging information acquisition and transmission section 1033 to obtain the charging information from the print job without depending on the command system of the command included in the print job. In other words, it is possible for the charging information acquisition and transmission section 1033 to obtain the charging information from the print job without depending on the type of the printer driver 113.

By using the first terminal communication section 11, the charging information acquisition and transmission section 1033 transmits the obtained charging information to the server 3 associated with the print queue by the related information 115, which stores the print job having the obtained charging information. When the spooler 1111 receives a print end response for the print job whose charging information has been obtained, the charging information acquisition and transmission section 1033 transmits the charging information to the server 3 in accordance with the related information 115. When the spooler 1111 receives an error response for the print job whose charging information has been obtained, the charging information acquisition and transmission section 1033 does not transmit the charging information to the server 3.

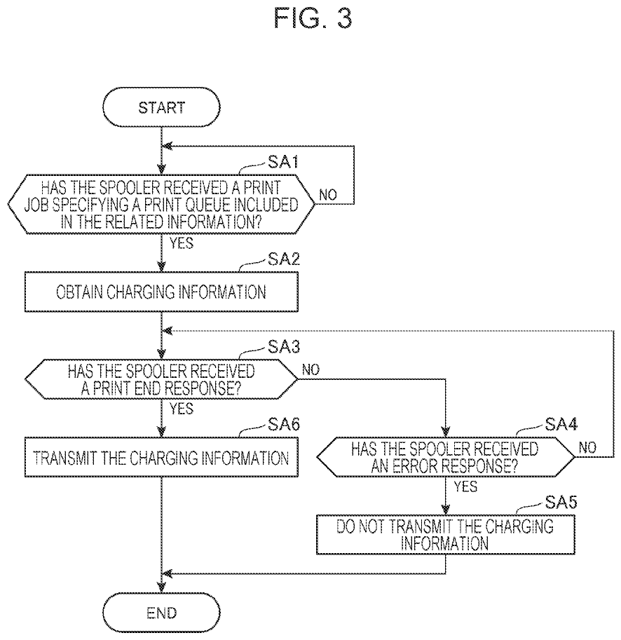

Next, a description will be given of the operation of the terminal device 1 according to the present embodiment. FIG. 3 is a flowchart illustrating the operation of the terminal device 1.

The monitoring section 1032 of the charging application execution section 103 determines whether or not the spooler 1111 has received a print job specifying the print queue included in the related information 115 (step SA1).

When the monitoring section 1032 determines that the spooler 1111 has not received a print job specifying the print queue included in the related information 115 (step SA1: NO), the monitoring section 1032 performs the processing of step SA1 again.

When the monitoring section 1032 determines that the spooler 1111 has received a print job specifying the print queue included in the related information 115 (step SA1: YES), the charging information acquisition and transmission section 1033 obtains the charging information from the print job received by the spooler 1111 (step SA2).

The monitoring section 1032 determines whether or not the spooler 1111 has received a print end response for the print job whose charging information has been obtained in step SA2 (step SA3).

When the monitoring section 1032 determines that the spooler 1111 has not received the print end response (step SA3: NO), the monitoring section 1032 determines whether or not the spooler 1111 has received an error response for the print job whose charging information has been obtained in step SA2 (step SA4).

When the monitoring section 1032 determines that the spooler 1111 has not received the error response (step SA4: NO), the processing returns to step SA3, and the determination of step SA3 is performed again.

On the other hand, when the monitoring section 1032 determines that the spooler 1111 has received the error response (step SA4: YES), the charging information acquisition and transmission section 1033 does not transmit the charging information obtained in step SA2 to the server 3 (step SA5).

Referring back to the description of step SA3, when the monitoring section 1032 determines that the spooler 1111 has received a print end response (step SA3: YES), the charging information acquisition and transmission section 1033 transmits the charging information obtained in step SA2 based on the related information 115 to the server 3 (step SA6).

Next, a description will be given of a second embodiment. In the second embodiment, compared with the embodiment described above, the operations of the charging application execution section 103 and the server 3 differ from those in the embodiment described above. When the charging information acquisition and transmission section 1033 of the charging application execution section 103 according to the second embodiment obtains the charging information from the print job, the charging information acquisition and transmission section 1033 transmits the obtained charging information to the server 3 based on the related information 115 even when the spooler 1111 has not received a print end response or an error response. After the charging information acquisition and transmission section 1033 transmits the charging information, when the spooler 1111 receives a print end response or an error response, the charging information acquisition and transmission section 1033 transmits the received response to the server 3 to which the charging information has been transmitted. When the server 3 receives the print end response from the terminal device 1, the server 3 performs various kinds of processing related to the charging based on the received charging information, whereas when the server 3 receives the error response from the terminal device 1, the server 3 dose not process the received charging information.

With each embodiment described above, the following advantages are obtained.

The charging application 114 executed by the terminal processor 100 of the terminal device 1 causes the terminal processor 100 to store a print queue and the server 3 to which the charging information is transmitted in association with each other. The spooler 1111 that receives a print job is monitored, and when the spooler 1111 receives a print job specifying a print queue, the spooler 1111 is caused to obtain charging information based on the print job and caused to transmit the obtained charging information to the server 3 associated with the print queue by the related information.

In the control method of the terminal device 1 connected to the server 3 that receives the charging information, the print queue and the server 3 to which the charging information is transmitted are stored in association with each other, and the spooler 1111 receives a print job. It is determined whether or not the print job received by the spooler 1111 is a print job specifying the print queue associated with the server 3. When the received print job is determined as the print job specifying the print queue associated with the server 3, the charging information based on the print job is transmitted to the server 3 associated with the print queue.

The terminal device 1 connected to the server 3 that receives the charging information includes the terminal storage section 110 that stores a print queue and a server to which the print information is transmitted in association with each other, the spooler 1111 that receives a print job, the monitoring section 1032 that monitors the spooler 1111, and the charging information acquisition and transmission section 1033 that transmits the charging information based on the print job to the server 3 associated by the related information 115 when the monitoring section 1032 determines that the print job received by the spooler 1111 is the print job specifying the print queue associated with the server 3.

With the charging application 114 and the control method of the terminal device 1, the terminal device 1 transmits the charging information based on the print job specifying the print queue to the server 3 associated with the print queue in the related information, and it is thus possible to transmit the charging information of a predetermined print job to the server 3 without transmitting the charging information of all of the print jobs to the server 3.

Regarding private printing and business printing, when a user uses the printer 2 for business printing, the user specifies a print queue set for business printing included in the related information 115 at the time of printing so that it is possible for the terminal device 1 to transmit the charging information of the print job regarding business printing to the server 3. Accordingly, when the printer 2 is used for both private printing and business printing, such as in a work-from-home scenario, it is possible to suitably transmit the charging information regarding business printing to the server 3.

The terminal device 1 obtains the charging information based on the print job from a predetermined storage area of the print job without performing command analysis, and it is thus possible to transmit the charging information to the server 3 without depending on the model and the manufacturer of the printer 2 connected to the terminal device 1. Accordingly, it is possible to configure a system in which the server 3 is enabled to process the charging information of the print job without depending on the model and the manufacturer of the printer 2 connected to the terminal device 1.

When the spooler 1111 receives a print job specifying a print queue that is not associated with the server 3 in the related information from the generation application 112, the charging application 114 does not cause the terminal processor 100 to transmit the print information to the server 3.

Accordingly, it is possible for the terminal device 1 to transmit the charging information of the print job specifying a predetermined print queue and to not transmit the charging information of the print job specifying the print queue other than the predetermined print queue. Accordingly, the user is able to determine whether or not to transmit the charging information in accordance with the specified print queue.

When the charging application 114 receives a print end response for the print job from the printer 2 connected to the terminal device 1, the charging application 114 causes the terminal processor 100 to transmit the charging information to the server 3.

Accordingly, it is possible to transmit the charging information of the print job that has ended the printing to the server 3, and it is thus possible for the server 3 to process the charging information of the print job that has ended the printing. That is to say, it is possible for the server 3 to perform processing on the charging information of the print job that has actually ended the printing, and it thus becomes possible to suitably perform various kinds of processing related to the charging.

When an error response for the print job is received from the printer 2 connected to the terminal device 1, the charging application 114 does not cause the terminal processor 100 to transmit the charging information to the server 3.

Accordingly, the terminal device 1 does not transmit the charging information of the print job that has not ended the printing to the server 3, and it is thus possible to prevent the server 3 from processing the charging information of the print job that has not ended the printing.

After the charging information is transmitted to the server 3, when a response for the print job is received from the printer 2 connected to the terminal device 1, the charging application 114 causes the terminal processor 100 to transmit the response to the server 3.

Accordingly, it is possible for the terminal device 1 to cause the server 3 to perform processing in accordance with the response for the print job from the printer 2. More specifically, when the terminal device 1 receives a print end response from the printer 2, it is possible for the terminal device 1 to cause the server 3 to process the charging information of the print job that has ended the printing by transmitting the print end response to the server 3. Also, when the terminal device 1 receives an error response from the printer 2, it is possible for the terminal device 1 to not cause the server 3 to process the charging information of the print job that has not ended the printing by transmitting the error response to the server 3.

The charging application 114 causes the terminal processor 100 to receive user input and to generate related information 115 associating the print queue and the server 3 based on the received user input.

Accordingly, it is possible for the terminal device 1 to transmit the charging information based on the related information 115 associating the print queue specified by the user and the server 3, and thus, unintended transmission of the charging information to the server 3 by the user is prevented.

Each embodiment described above represents one mode, and thus it is possible to change and apply in any way.

The charging application execution section 103 described above has the configuration in which the server 3 transmits the charging information. However, when it is possible for the server 3 to analyze the commands included in the command system of the printer 2 connected to the terminal device 1, it may be possible to transmit the print job from which the charging information has been obtained together with the charging information.

The print information that the terminal device 1 transmits to the server 3 is determined to be the charging information, and the server 3 preforms the processing related to the charging based on the charging information. However, the server 3 may be a server device that performs the processing related to printing results, such as collecting the number of sheets printed, and the like based on the information transmitted from the terminal device 1, and providing the collection result. In this case, it is possible to consider the print information to be the information indicating printing results.

The printer 2 may include functions other than the print function, such as a scan function, a facsimile function, and the like.

The functions of the terminal controller 10 may be realized by a plurality of processors or semiconductor chips.

Each section illustrated in FIG. 1 is an example and is not limited particularly. It is not necessary that hardware corresponding to each section is implemented, and it is of course possible to employ the configuration in which the function of each section is realized by one processor executing a program. A part of the functions realized by software may be implemented by hardware, or a part of the functions realized by hardware may be implemented by software. In addition, it is possible to change the specific detailed configuration of the other each section of the terminal device 1 in any manner.

The step unit of the operation illustrated in FIG. 3 is produced by dividing the processing in accordance with the main processing contents to facilitate understanding of the operation of the terminal device 1, and is not limited by the way of dividing the processing unit. The step unit may be divided into further more step units in accordance with the processing contents. Also, one step unit may include further more processing. Also, the order of the steps may be suitably replaced.

What is claimed is:

1. A non-transitory computer-readable storage medium storing a print control program to be executed by a computer of a print controller, the print controller connected to a server and a printer and including a spooler operating to receive a print job and transmit the print job to the printer, the print control program causing the computer to perform processing, the processing comprising:
storing a print queue associated with the server;
monitoring the spooler;
when the spooler receives the print job, in a case in which the received print job specifies the print queue, obtaining print information based on the print job; and
transmitting the obtained print information to the server associated with the print queue.

2. The non-transitory computer-readable storage medium according to claim 1, further comprising:
causing the computer to store a second print queue not associated with the server; and
when the spooler receives the print job, in a case in which the print job specifies the second print queue, not transmitting the print information to the server.

3. The non-transitory computer-readable storage medium according to claim 1, further comprising:
when a print end response for the transmitted print job is received from the printer, causing the computer to transmit the print information to the server.

4. The non-transitory computer-readable storage medium according to claim 3, further comprising:
when an error response for the transmitted print job is received from the printer, causing the computer to not transmit the print information to the server.

5. The non-transitory computer-readable storage medium according to claim 1, further comprising:
after transmitting the print information to the server, when a response for the transmitted print job is received from the printer, causing the computer to transmit the response to the server.

6. The non-transitory computer-readable storage medium according to claim 1, further comprising:
causing the computer to receive user input and generate the print queue associated with the server based on the received user input.

7. A method of controlling a print controller connected to a server and a printer, the method comprising:
storing a print queue associated with the server;
receiving a print job by using a spooler;
determining whether or not the print job received by the spooler specifies the print queue;
when determining that the print job specifies the print queue, transmitting print information based on the print job to the server associated with the print queue.

8. The method of controlling a print controller according to claim 7, further comprising:
storing a second print queue not associated with the server; and
when the spooler receives the print job, in a case in which the print job specifies the second print queue, not transmitting the print information to the server.

9. The method of controlling a print controller according to claim 7, further comprising:
when receiving a print end response for the transmitted print job, transmitting the print information to the server.

10. The method of controlling a print controller according to claim 9, further comprising:
when receiving an error response for the transmitted print job, not transmitting the print information to the server.

11. The method of controlling a print controller according to claim 7, further comprising:
after transmitting the print information to the server, when a response for the transmitted print job is received from the printer, transmitting the response to the server.

12. The method of controlling a print controller according to claim 7, further comprising:
receiving user input, and
generating the print queue associated with the server based on the received user input.

13. A print controller connected to a server and a printer, comprising:
a storage section configured to store a print queue associated with the server;
a spooler configured to receive a print job;
a monitoring section configured to monitor the spooler; and
a print information transmission section configured to transmit print information based on the print job to the print queue and the server when the monitoring section determines that the print job received by the spooler specifies a print queue.

14. The print controller according to claim 13, wherein
the storage section further stores a second print queue not associated with the server, and
when the monitoring section determines that the print job received by the spooler specifies the second print queue, the print information transmission section does not transmit the print information to the server.

15. The print controller according to claim 13, wherein
when the spooler receives a print end response for the transmitted print job from the printer, the print information transmission section transmits the print information to the server.

16. The print controller according to claim 15, wherein
when the spooler receives an error response for the transmitted print job from the printer, the print information transmission section does not transmit the print information to the server.

17. The print controller according to claim 13, wherein
after the print information transmission section transmits the print information to the server, when the spooler receives a response for the transmitted print job from the printer, the print information transmission section transmits the response to the server.

18. The print controller according to claim 13, further comprising:
an input section configured to receive user input; and
a terminal controller configured to generate the print queue associated with the server based on the user input received by the input section.
